(19) United States
(12) Patent Application Publication
(10) Pub. No.: US 2007/0066243 A1
(43) Pub. Date: Mar. 22, 2007

(54) Rf circuit module

(76) Inventors: Atsushi Yamauchi, Shiga-ken (JP); Hiroaki Kitada, Shiga-ken (JP); Masakazu Hori, Shiga-ken (JP); Osamu Tamakoshi, Shiga-ken (JP); Makoto Fujita, Shiga-ken (JP)

Correspondence Address: MURATA MANUFACTURING COMPANY, LTD.;C/O KEATING & BENNETT, LLP, 8180 GREENSBORO DRIVE, SUITE 850, MCLEAN, VA, 22102, US

(21) Appl. No.: 10/545,046

(22) PCT Filed: Jan. 25, 2005
(86) PCT No.: PCT/JP05/00903

§ 371 Date: Aug. 11, 2005

(30) Foreign Application Priority Data
Sep. 27, 2004 (JP) 2004-280335

(51) Int. Cl. H04B 1/44

(52) U.S. Cl. 455/78

(57) ABSTRACT

An RF circuit module includes a laminated dielectric substrate defining an RF circuit module and including an upper layer and a lower layer. An IC and an RF filter are disposed in the upper layer, and a power amplifier and an antenna switch are disposed in the lower layer. The antenna switch is disposed near an end surface of the laminated dielectric substrate, and the RF amplifier is disposed at a position at which it partially overlaps the antenna switch in a plan view. The IC and the power amplifier are also disposed at positions at which they partially overlap each other in a plan view.

### BACKGROUND OF THE INVENTION

1. Field of the Invention

The present invention relates to an RF circuit module connected between an RF antenna and a signal processor which processes baseband signals.

2. Description of the Related Art

In general, with the reduction in size of communication devices such as portable telephones, a plurality of function units are often configured into a single module, instead of individual ICs or circuits, and this module is mounted on a base substrate of a communication device. Recently, RF circuit modules in which the entire RF circuit between a digital signal processor and an RF antenna is provided as a single module have been demanded as portable communication modules.

The RF circuit includes a high-frequency signal processor, a power amplifier, an antenna switch, and a receiving filter.

The high-frequency signal processor includes a least a modulator that modulates a carrier signal with a signal for transmission to generate a transmission signal (RF signal), and a demodulator that demodulates a received signal (RF signal) from the receiving filter to output the received signal. The high-frequency signal processor may be provided as a one-chip IC. The power amplifier amplifies the transmission signal from the high-frequency processor. Unlike the high-frequency signal processor, the power amplifier generates heat, and therefore, heat radiation must be taken into consideration. The antenna switch switches between a connection between the RF antenna and the power amplifier and a connection between the RF antenna and the receiving filter. The receiving filter only transmits a required frequency band component of the received signal, and outputs the transmitted component to the demodulator in the high-frequency processor circuit. Typically, a SAW filter is used as the receiving filter. These four function units can only be configured as substantially separate components to achieve their respective functions. An RF circuit module including these components is disclosed in Japanese Unexamined Patent Application Publication No. 2001-237735 in which component components of the RF circuit are mounted on the top and bottom surfaces (front and back surfaces) of a substrate for an RF circuit.

The RF circuit module disclosed in Japanese Unexamined Patent Application Publication No. 2001-237735 is configured such that the RF circuit components are mounted on the front and back surfaces, or on both surfaces, of the substrate, and is more space efficient than the configuration in which all components are mounted on one surface (one side) of a base substrate of a portable communication device. However, since the RF circuit module includes components on both sides of the substrate, in order to mount the RF circuit module on a base substrate, it is necessary to dispose a recessed portion on the base substrate so as to prevent the components on the back surface from being in contact with the base substrate. This causes low yield and high production cost.

### SUMMARY OF THE INVENTION

To overcome the problems described above, preferred embodiments of the present invention provide an RF circuit module that can be mounted on a base substrate of a portable communication device without any special processing and that is space efficient.

According to a preferred embodiment of the present invention, an RF circuit module includes a high-frequency signal processor for transmission and reception including a modulation circuit that modulates a carrier signal with a transmitting signal to generate a transmission signal, and a demodulation circuit that demodulates a received signal to generate a reception signal, a transmitter power amplifier that amplifies the transmission signal, a signal distributor having an input terminal to which the amplified transmission signal is input, an antenna terminal from which the input amplified transmission signal is output, and an output terminal from which the received signal input from the antenna terminal is output, and a receiver filter that transmits only a required frequency band component of the received signal output from the signal distributor, wherein a first layer on which the high-frequency signal processor for transmission and reception is disposed, and a second layer on which the signal distributor is disposed are provided as an upper layer and a lower layer, one of the transmitter power amplifier and the receiver filter is disposed on the first layer and the other is disposed on the second layer, and the transmitter power amplifier and the receiver filter are disposed so as to be close to or overlapping the high-frequency signal processor for transmission and reception or the signal distributor disposed in the other layer in a plan view.

With this structure, the transmitter power amplifier and the receiver filter connected to the high-frequency signal processor for transmission and reception are disposed in different layers, and are arranged so that they are close to or overlap the high-frequency signal processor for transmission and reception. Thus, a wiring pattern connecting the high-frequency signal processor for transmission and reception and the transmitter power amplifier and a wiring pattern connecting the high-frequency signal processor for transmission and reception and the receiver filter can be reduced. With this structure, furthermore, the transmitter power amplifier and the receiver filter connected to the signal distributor are disposed in different layers, and are arranged so that they are close to or overlap the signal distributor. Thus, a wiring pattern connecting the signal distributor and the transmitter power amplifier and a wiring pattern connecting the signal distributor and the receiver filter can be reduced.

In the RF circuit module according to a preferred embodiment of the present invention, a layer of the first layer and the second layer on which the transmitter power amplifier is disposed serves as the lower layer, and the layer on which the receiver filter is disposed serves as the upper layer.

With this structure, the transmitter power amplifier is disposed in the lower layer, which is a layer to be mounted on a base substrate of a portable communication device. Thus, the distance between the transmitter power amplifier and the base substrate having a heat radiation function can be reduced.

In the RF circuit module according to a preferred embodiment of the present invention, the second layer on which the signal distributor is disposed serves as the lower layer, and the first layer on which the high-frequency signal processor for transmission and reception is disposed serves as the upper layer.

With this structure, the signal distributor is disposed in the lower layer, which is a layer to be mounted on a base substrate of a portable communication device. Thus, the distance between the signal distributor and the base substrate on which the RF antenna is mounted can be reduced.

The RF circuit module according to a preferred embodiment of the present invention includes a first circuit substrate on which the circuits in the first layer are defined, a second circuit substrate on which circuits in the second layer are defined, and a conductor arranged to provide conduction between the first circuit substrate and the second circuit substrate in a lamination direction.

With this structure, the first layer and the second layer are different circuit substrates. Thus, if one of the circuit substrates has a problem, only the corresponding circuit substrate needs to be replaced.

The RF circuit module according to preferred embodiments of the present invention is a laminated multilayer circuit substrate having a top portion on which the circuits in the upper layer are defined, and a bottom portion in which the circuits in the lower layer are included. The laminated multilayer circuit substrate includes conducting elements for providing conduction between the lower layer and the upper layer.

With this structure, the upper layer and the lower layer are formed of a single laminated multilayer circuit substrate. Thus, there is no need for the above-described operation process for connecting the first layer and the second layer. Moreover, due to the laminated structure, the RF circuit module has a small thickness.

In the RF circuit module according to preferred embodiments of the present invention, the signal distributor is an antenna switch.

In the RF circuit module according to preferred embodiments of the present invention, the transmitter power amplifier and the receiver filter are close to the high-frequency signal processor for transmission and reception, and the transmitter power amplifier and the receiver filter are close to the signal distributor. Moreover, wiring patterns for connecting these component elements are relatively short. Therefore, the RF circuit module is space efficient.

Components in different layers partially overlap each other in a plan view so as to provide shorter wiring patterns between the components. Therefore, the RF circuit module is even more space efficient.

In the RF circuit module according to preferred embodiments of the present invention, the transmitter power amplifier is disposed in the lower layer that is close the base substrate so as to allow the heat generated by the transmitter power amplifier to rapidly propagate to the base substrate so as to provide efficient heat radiation.

In the RF circuit module according to preferred embodiments of the present invention, the signal distributor is disposed in the lower layer near the base substrate so as to provide a short distance between the signal distributor and the RF antenna. Therefore, the transmission characteristic of transmission signals and received signals are improved.

In the RF circuit module according to preferred embodiments of the present invention, two circuit substrates are laminated together so as to provide a highly repairable RF circuit module because, if one of the circuit substrates has a problem, only the corresponding circuit substrate needs to be replaced.

In the RF circuit module according to preferred embodiments of the present invention, the RF circuit module is defined by a single laminated multilayer circuit substrate so as to enable the RF circuit module to be incorporated in a communication device only by mounting the laminated multilayer circuit substrate on a base substrate. Moreover, due to the laminated structure, the RF circuit module has a smaller thickness.

Other features, elements, steps, characteristics, and advantages of the present invention will become more apparent from the following description of preferred embodiments of the present invention with reference to the attached drawings.

### BRIEF DESCRIPTION OF THE DRAWINGS

FIG. 1 is a block diagram schematically showing the structure of a communication device including an RF circuit module according to a first preferred embodiment of the present invention.

FIG. 2 is a side cross-sectional view schematically showing the structure of the RF circuit module according to the first preferred embodiment of the present invention.

FIG. 3 includes a plan view schematically showing the structure of a lower layer 12 of the RF circuit module shown in FIG. 2, and a plan view schematically showing the structure of a developed pattern thereof.

FIG. 4 is a side cross-sectional view schematically showing the structure of an RF circuit module according to a second preferred embodiment of the present invention.

### DETAILED DESCRIPTION OF PREFERRED EMBODIMENTS

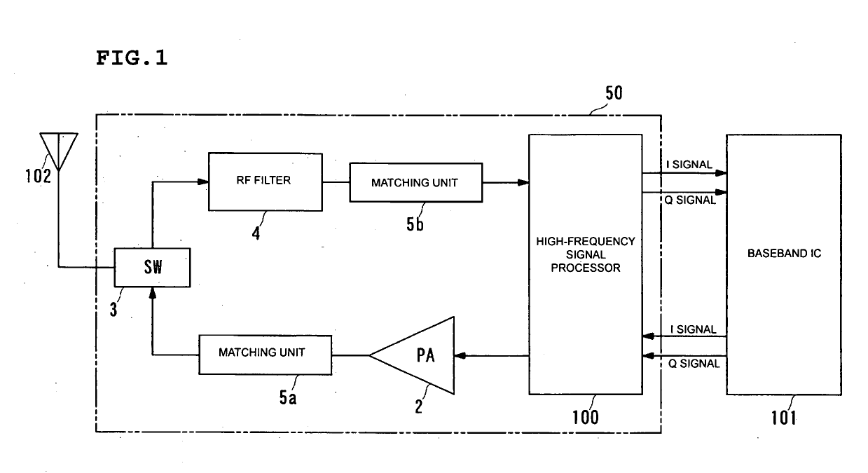

An RF circuit module according to a first preferred embodiment of the present invention will be described with reference to FIGS. 1 to 3.

FIG. 1 is a block diagram schematically showing the structure of a communication device including the RF circuit module according to the first preferred embodiment of the present invention.

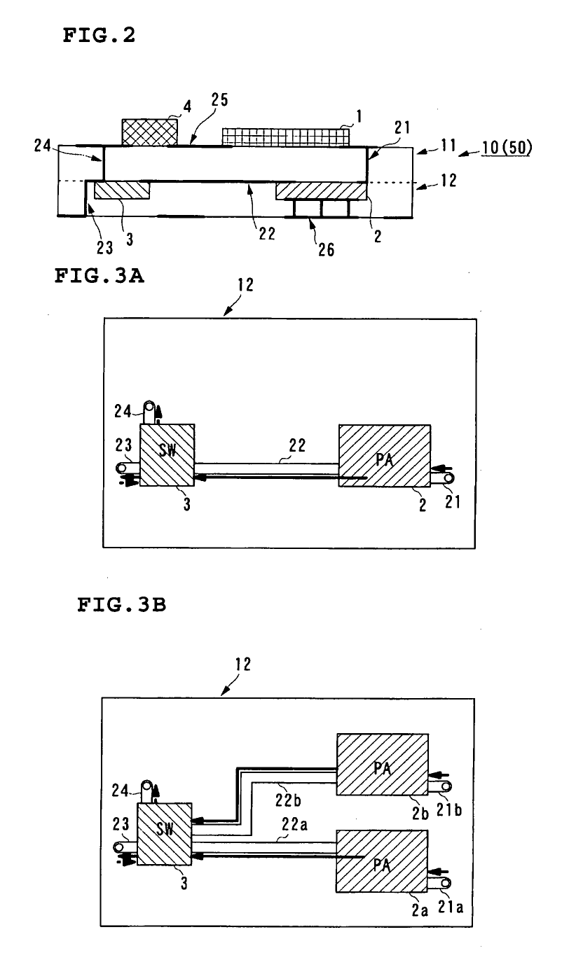

FIG. 2 is a side cross-sectional view schematically showing the structure of the RF circuit module according to the first preferred embodiment of the present invention. FIG. 2 is a side cross-sectional view to clearly show the connection between component elements of the RF circuit module.

FIG. 3(a) is a plan view schematically showing the structure of a lower layer 12 of the RF circuit module shown in FIG. 2, showing only a wiring pattern that provides conduction between main component elements of the present invention. FIG. 3(b) shows the lower layer 12 in which two power amplifiers 2 are disposed. In FIG. 3, thick solid arrows indicate transmission-signal transmission lines, and thick broken arrows indicate reception-signal transmission lines.

As shown in FIG. 1, a communication device including the RF circuit module according to the first preferred embodiment includes an RF circuit module 50 according to the present invention, a baseband IC 101, and an RF antenna 102.

The RF circuit module 50 includes a high-frequency signal processor 100 for transmission and reception, which is defined by an IC, a transmitter power amplifier (PA) 2, an antenna switch (SW) 3, an RF filter 4, a matching unit 5a for matching between the power amplifier 2 and a circuit on the side of the antenna switch 3, and a matching unit 5b for matching between the RF filter 4 and the high-frequency signal processor 100. The antenna switch 3 corresponds to a “signal distributor” in the present invention.

The high-frequency signal processor 100 includes a modulator and a demodulator. The modulator modulates a carrier signal generated by a high-frequency oscillator (not shown) based on a transmitting digital signal for transmission including an in-phase signal (I signal) and a quadrature signal (Q signal) input from the baseband IC 101 to generate a transmission signal (RF signal), and outputs the transmission signal to the power amplifier 2. The demodulator demodulates a digital signal for reception from a received signal (RF signal) input from the RF filter 4 to generate an in-phase signal (I signal) and a quadrature signal (Q signal), and outputs the I and Q signals to the baseband IC 101. The digital signal for transmission corresponds to a “transmitting signal” in the present invention, and the digital signal for reception corresponds to a “reception signal” in the present invention.

The power amplifier 2 amplifies the transmission signal from the high-frequency signal processor 100, and outputs the amplified signal to the antenna switch 3 via the matching unit 5a.

The antenna switch 3 is switched by the baseband IC 101, and outputs from an antenna terminal to the RF antenna 102 the transmission signal input from the power amplifier 2 to an input terminal, or inputs from the antenna terminal the received signal received by the RF antenna 102 and outputs the received signal from an output terminal to the RF filter 4.

The RF filter 4 transmits only a required frequency-band signal from the received signal that is received by the RF antenna 102 and that is input via the antenna switch 3, and outputs the transmitted signal to the high-frequency signal processor 100 via the matching unit 5b.

The RF circuit module performing such transmission and reception signal processing has a structure shown in FIGS. 2 and 3(a).

The RF circuit module 50 includes a laminated multilayer dielectric substrate 10 in which a lower layer 12 and an upper layer 11 are laminated. Each of the lower layer 12 and the upper layer 11 includes component elements of the above-described RF circuit module mounted or defined thereon, and also includes a wiring pattern connecting the component elements. The upper layer 11 and the lower layer 12 are integrated into one unit.

The lower layer 12 includes the antenna switch 3 and the power amplifier 2 mounted or defined thereon, and also includes a transmission-signal transmission line 22 that provides conduction between the antenna switch 3 and the power amplifier 2. The power amplifier 2 and the antenna switch 3 may be mounted on the lower layer 12 by a known technique, e.g., by providing a cavity in advance and inserting the elements into the cavity. The matching unit 5a shown in FIG. 1 may be used as the transmission-signal transmission line 22, or an element connected to the transmission-signal transmission line 22. In the first preferred embodiment, the lower layer 12 having the antenna switch 3 corresponds to a “second layer” in the present invention.

The antenna switch 3 is mounted on the lower layer 12 (or the laminated multilayer dielectric substrate 10) near an end surface thereof, and is connected to an antenna connection line 23. The antenna connection line 23 includes a transmission/reception line pattern defined on a surface of the lower layer 12 near the upper layer 11, an antenna connection electrode pattern defined on the bottom surface of the lower layer 12 (or the bottom surface of the laminated multilayer dielectric substrate 10), and a through-hole that provides conduction between the electrode pattern and the wiring pattern in the lamination direction. Via a base substrate (not shown) of the communication device on which the RF circuit module 50 (or the laminated multilayer dielectric substrate 10) is mounted, the antenna connection line 23 is in conduction with the RF antenna 102 mounted on the base substrate. The antenna switch 3 is in conduction with the RF filter 4 mounted on the top surface of the upper layer 11 by a reception-signal transmission line 24. The reception-signal transmission line 24 includes a reception line pattern defined on a surface of the lower layer 12 near the upper layer 11, a reception line pattern defined on the top surface of the upper layer 11, and a through-hole (corresponding to “conductor” in the present invention) defined in the upper layer 11 for providing conduction between the reception line patterns in the lamination direction. Accordingly, the antenna switch 3 is disposed near an end surface of the lower layer 12 so as to reduce the signal transmission distance between the antenna switch 3 and the base substrate and the signal transmission distance between the antenna switch 3 and the RF antenna 102. Therefore, a transmission loss or a mismatch caused by parasitic impedance is prevented between the antenna switch 3 and the RF antenna 102. That is, transmission signals and received signals are transmitted between the antenna switch 3 and the RF antenna 102 with low loss.

The power amplifier 2 is disposed a predetermined distance from the antenna switch 3, and is in conduction with an IC 1 which provides the high-frequency signal processor 100 (hereinafter referred to simply as an “IC 1”) mounted on the top surface of the upper layer 11 by a transmission-signal transmission line 21. The transmission-signal transmission line 21 includes a transmission line pattern defined on a surface of the lower layer 12 near the upper layer 11, a transmission line pattern defined on the top surface of the upper layer 11, and a through-hole (corresponding to “conductor” in the present invention) defined in the upper layer 11 for providing conduction between the transmission line patterns in the lamination direction.

The power amplifier 2 is further connected to a ground pattern 26. The ground pattern 26 includes a ground electrode pattern defined in the lower layer 12 at a location at which the power amplifier 2 is disposed, a ground electrode pattern defined on the bottom surface of the lower layer 12 (or the bottom surface of the laminated dielectric substrate 10), and a plurality of through-holes that provides conduction between the ground electrode patterns in the lamination direction. The ground pattern 26 is in conduction with a ground electrode on the base substrate (not shown) of the communication device on which the RF circuit module 50 (or the laminated dielectric substrate 10) is mounted. The ground pattern 26 and the ground electrode ground the power amplifier 2, and enable the heat generated by the power amplifier 2 to be radiated. Accordingly, the power amplifier 2 is disposed in the lower layer 12 so as to reduce the distance between the power amplifier 2 and the base substrate and provide efficient heat radiation.

The IC 1 and the RF filter 4 are mounted on the top surface of the upper layer 11 (or the laminated dielectric substrate 10), and the IC 1 and the RF filter 4 are connected by a reception-signal transmission line 25 defined on the top surface of the upper layer 11. The matching unit 5b shown in FIG. 1 may be used as the reception-signal transmission line 25, or an element connected to the reception-signal transmission line 25. In the first preferred embodiment, the upper layer 11 having the IC 1 mounted thereon corresponds to a “first layer” in the present invention.

The IC 1 is mounted on the top surface of the upper layer 11 at a location close to the location at which the power amplifier 2 is disposed in the lower layer 12. That is, the IC 1 and the power amplifier 2 are disposed at locations at which the IC 1 and the power amplifier 2 are close to each other, preferably, at locations at which they at least partially overlap each other, in a plan view. As described above, the IC 1 is in conduction with the power amplifier 2 disposed in the lower layer 12 via the transmission-signal transmission line 21, and is also in conduction with the RF filter 4 mounted on the top surface of the upper layer 11 via the reception-signal transmission line 25. Accordingly, the IC 1 and the power amplifier 2 are close to each other or overlap each other in a plan view such that the line length of the transmission-signal transmission line 21 that provides conduction between the IC 1 and the power amplifier 2 is substantially the same as the height of the through-hole, i.e., the thickness of the upper layer 11. Thus, the line length is greatly reduced. Therefore, a transmission loss or a mismatch caused by the parasitic impedance is prevented between the IC 1 and the power amplifier 2. That is, transmission signals are transmitted between the IC 1 and the power amplifier 2 with low loss.

The RF filter 4 is a filter element, such as a SAW filter, and is mounted on the top surface of the upper layer 11 at a location near the position at which the antenna switch 3 is disposed in the lower layer 12. That is, the RF filter 4 and the antenna switch 3 are disposed at locations at which the RF filter 4 and the antenna switch 3 are close to each other, preferably, at locations at which they at least partially overlap each other, in a plan view. As described above, the RF filter 4 is in conduction with the antenna switch 3 disposed in the lower layer 12 via the reception-signal transmission line 24, and is also in conduction with the IC 1 mounted on the top surface of the upper layer 11 via the reception-signal transmission line 25. Accordingly, the RF filter 4 and the antenna switch 3 are close to each other or at least partially overlap each other in a plan view such that the line length of the reception-signal transmission line 24 that provides conduction between the RF filter 4 and the antenna switch 3 is substantially the same as the height of the through-hole, i.e., the thickness of the upper layer 11. Thus, the line length is greatly reduced. Therefore, a transmission loss or a mismatch caused by the parasitic impedance is prevented between the antenna switch 3 and the RF filter 4. That is, received signals are transmitted between the antenna switch 3 and the RF filter 4 with low loss.

Therefore, with the structure of the first preferred embodiment, the component elements of the RF circuit module are separately disposed in two layers, and the outer dimensions of the RF circuit module in a plan view are reduced, which contributes to space efficiency. Thus, the communication device including this RF circuit module is compact. Moreover, due to the laminated structure, the RF circuit module has a reduced thickness.

Furthermore, the antenna switch is disposed near an end surface of the RF circuit module in the lower layer, i.e., a layer close to the base substrate. Thus, the line length of a high-frequency line that provides conduction between the antenna switch and the RF antenna is reduced, which results in low-loss transmission of transmission signals and received signals.

Furthermore, the antenna switch and the RF filter are disposed at locations at which they partially overlap each other in a plan view, and the IC and the power amplifier are disposed at locations at which they partially overlap each other in a plan view. Thus, the line length of these two lines is substantially as short as the thickness of the upper layer of the laminated dielectric substrate defining the RF circuit module, which results in low-loss transmission of transmission signals and received signals.

Furthermore, the power amplifier is disposed in the lower layer, i.e., a layer close to the base substrate. Thus, the distance between the ground electrode on the mounting substrate with high heat radiation and the power amplifier is reduced, and the heat radiation of the power amplifier is improved.

Furthermore, the power amplifier and the RF filter are disposed in different layers. Thus, the heat generated from the power amplifier is prevented from being transmitted to the RF filter, and characteristic deterioration of the RF filter due to the heat is prevented.

Furthermore, since no components are mounted on the bottom surface of the RF circuit module, the RF circuit module can be surface-mounted on the base substrate without processing such as recessing a surface of the base substrate. The step of processing the base substrate is therefore omitted, which reduces production load and cost.

While one power amplifier is provided in the foregoing description, as shown in FIG. 3(b), the foregoing structure can also be applied to two power amplifiers for use in a dual-band RF module. In this case, power amplifiers 2a and 2b are in conduction with the antenna switch 3 using transmission-signal transmission lines 22a and 22b, respectively, and the power amplifiers 2a and 2b are in conduction with the IC 1 using transmission-signal transmission lines 21a and 21b, respectively. The remaining structure is the same as the above-described structure.

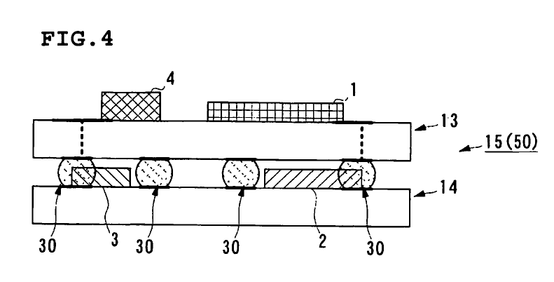

Next, an RF circuit module according to a second preferred embodiment will be described with reference to FIG. 4.

FIG. 4 is a side cross-sectional view schematically showing the structure of the RF circuit module according to the second preferred embodiment of the present invention. Although the transmission-signal transmission lines, the reception-signal transmission lines, the antenna connection line, and the ground pattern shown in FIG. 2 are not shown in FIG. 4, wiring patterns and through-holes corresponding to these lines and the patterns are defined in a similar manner to that in the first preferred embodiment of the present invention.

As shown in FIG. 4, an RF circuit module member 15 (corresponding to the RF circuit module 50 shown in FIG. 1) according to the second preferred embodiment includes an upper dielectric substrate 13, a lower dielectric substrate 14, and a plurality of connecting members 30 electrically and physically connecting these substrates in the lamination direction.

An IC 1 and an RF filter 4 are mounted on the top surface of the upper dielectric substrate 13 in a similar manner to that in the first preferred embodiment, and the IC 1 and the RF filter 4 are in conduction with a top-surface electrode pattern defined on the top surface. The top-surface electrode pattern is in conduction with a back-surface electrode pattern defined on the back surface via through-holes.

A power amplifier 2 and an antenna switch 3 are mounted on the top surface of the lower dielectric substrate 14 in a similar manner to that in the first preferred embodiment, and the power amplifier 2 and the antenna switch 3 are in conduction with a top-surface electrode pattern defined on the top surface.

The connecting members 30 are preferably formed by soldering, a metal terminal member, a conducting ball, or other suitable manner, and connect the back-surface electrode pattern on the upper dielectric substrate 13 and the top-surface electrode pattern on the lower dielectric substrate 14. The connecting members 30, the back-surface electrode pattern on the upper dielectric substrate 13, and the top-surface electrode pattern on the lower dielectric substrate 14 define the above-described transmission-signal transmission lines and reception-signal transmission lines.

The positional relationship between the IC 1 and the power amplifier 2 in a plan view, and the positional relationship between the antenna switch 3 and the RF filter 4 in a plan view are the same as those in the first preferred embodiment of the present invention.

The upper dielectric substrate 13 on which the IC 1 is mounted and the lower dielectric substrate 14 on which the antenna switch 3 is mounted correspond to a “first circuit substrate” and a “second circuit substrate” in the present invention, respectively. The connecting members 30 correspond to “conducting elements” in the present invention.

With this structure, similarly to the first preferred embodiment, the component members of the RF circuit module are disposed in two stages. Thus, the outer dimensions in a plan view are reduced, which contributes to space efficiency.

With this structure, furthermore, the RF circuit module includes of two dielectric substrates, i.e., a dielectric substrate having a function unit including the RF filter 4 and the IC 1 and a dielectric substrate having a function unit including the power amplifier 2 and the antenna switch 3. If one of the function units fails or is updated, only the corresponding dielectric substrate needs to be replaced. Therefore, an RF circuit module that is highly repairable and highly flexible in design change is achieved.

Furthermore, the RF filter and the power amplifier are mounted on different dielectric substrates. Thus, the heat generated by the power amplifier is prevented from transmitting to the RF filter. Therefore, an RF circuit module which prevents characteristic deterioration of the RF filter due to the heat is achieved.

In the foregoing preferred embodiments, the IC and the RF filter are disposed in the upper layer (or the upper substrate), and the antenna switch and the power amplifier are disposed in the lower layer (or the lower substrate), by way of example. There may be various combinations thereof depending on the desired design and shape. For example, a combination of the IC and the power amplifier in the upper layer and the antenna switch and the RF filter in the lower layer, a combination of the antenna switch and the power amplifier in the upper layer and the IC and the RF filter in the lower layer, and a combination of the antenna switch and the RF filter in the upper layer and the IC and the power amplifier in the lower layer could be provided. In such arrangements, the power amplifier and the RF filter are disposed so as to be close to or partially overlap the IC and the antenna switch disposed in the other layer in a plan view. In either case, the component members of the RF circuit module are disposed in two layers (or two stages), thus achieving a space-efficient RF circuit module.

The signal distributor is not limited to the antenna switch, and may be, for example, a duplexer using a SAW filter or other suitable device.

While the present invention has been described with respect to preferred embodiments thereof, it will be apparent to those skilled in the art that the disclosed invention may be modified in numerous ways and may assume many embodiments other than those specifically set out and described above. Accordingly, it is intended by the appended claims to cover all modifications of the invention which fall within the true spirit and scope of the invention.

1-6. (canceled)

7: An RF circuit module comprising:
a high-frequency signal processor for transmission and reception including a modulation circuit that modulates a carrier signal with a transmitting signal to generate a transmission signal, and a demodulation circuit that demodulates a received signal to generate a reception signal;
a transmitter power amplifier that amplifies the transmission signal;
a signal distributor having an input terminal to which the amplified transmission signal is input, an antenna terminal from which the input amplified transmission signal is output, and an output terminal from which the received signal input from the antenna terminal is output; and
a receiver filter that transmits only a required frequency band component of the received signal output from the signal distributor; wherein
a first layer on which the high-frequency signal processor for transmission and reception is disposed, and a second layer on which the signal distributor is disposed are provided as an upper layer and a lower layer;
one of the transmitter power amplifier and the receiver filter is disposed on the first layer and the other of the transmitting power amplifier and the receiver filter is disposed on the second layer; and
the transmitter power amplifier and the receiver filter are arranged so as to be close to or overlap the high-frequency signal processor for transmission and reception or the signal distributor disposed in the other layer in a plan view.

8: The RF circuit module according to claim 7, wherein the layer of the first layer and the second layer on which the transmitter power amplifier is disposed defines the lower layer, and the layer on which the receiver filter is disposed defines the upper layer.

9: The RF circuit module according to claim 7, wherein the second layer defines the lower layer, and the first layer defines the upper layer.

10: The RF circuit module according to claim 7, further comprising a first circuit substrate on which circuits in the first layer are defined, a second circuit substrate on which circuits in the second layer are defined, and conductors arranged to provide conduction between the first circuit substrate and the second circuit substrate in a lamination direction.

11: The RF circuit module according to claim 10, wherein the RF circuit module includes a laminated multilayer circuit substrate having a top portion on which the circuits in the first layer are defined, and a bottom portion in which the circuits in the second layer are included, the laminated multilayer circuit substrate including conductors arranged to provide conduction between the first layer and the second layer.

12: The RF circuit module according to claim 7, wherein the signal distributor is an antenna switch.

13: The RF circuit module according to claim 7, wherein the high-frequency signal processor is an IC chip.

14: An RF circuit module comprising:
a high-frequency signal processor for transmission and reception;
a transmitter power amplifier that amplifies a transmission signal;
a signal distributor having an input terminal to which the amplified transmission signal is input, an antenna terminal from which the input amplified transmission signal is output, and an output terminal from which a received signal input from the antenna terminal is output; and
a receiver filter that transmits only a required frequency band component of the received signal output from the signal distributor; wherein
a first layer on which the high-frequency signal processor for transmission and reception is disposed, and a second layer on which the signal distributor is disposed are provided as an upper layer and a lower layer;
one of the transmitter power amplifier and the receiver filter is disposed on the first layer and the other of the transmitting power amplifier and the receiver filter is disposed on the second layer.

15: The RF circuit module according to claim 14, wherein the high-frequency signal processor includes a modulation circuit that modulates a carrier signal with a transmitting signal to generate a transmission signal, and a demodulation circuit that demodulates a received signal to generate a reception signal.

16: The RF circuit module according to claim 14, wherein the transmitter power amplifier and the receiver filter are disposed so as to be close to or overlap the high-frequency signal processor for transmission and reception or the signal distributor disposed in the other layer in a plan view.

17: The RF circuit module according to claim 14, wherein the layer of the first layer and the second layer on which the transmitter power amplifier is disposed defines the lower layer, and the layer on which the receiver filter is disposed defines the upper layer.

18: The RF circuit module according to claim 14, wherein the second layer defines the lower layer, and the first layer defines the upper layer.

19: The RF circuit module according to claim 14, further comprising a first circuit substrate on which circuits in the first layer are defined, a second circuit substrate on which circuits in the second layer are defined, and conductors arranged to provide conduction between the first circuit substrate and the second circuit substrate in a lamination direction.

20: The RF circuit module according to claim 19, wherein the RF circuit module includes a laminated multilayer circuit substrate having a top portion on which the circuits in the first layer are defined, and a bottom portion in which the circuits in the second layer are included, the laminated multilayer circuit substrate including the conductors arranged to provide conduction between the first layer and the second layer.

21: The RF circuit module according to claim 14, wherein the signal distributor is an antenna switch.

22: The RF circuit module according to claim 14, wherein the high-frequency signal processor is an IC chip.
